(19) United States
(12) Patent Application Publication
(10) Pub. No.: US 2005/0094628 A1
(43) Pub. Date: May 5, 2005

(54) Optimizing packetization for minimal end-to-end delay in VoIP networks

(76) Inventors: Boonchai Ngamwongwattana, Pittsburgh, PA (US); Richard A. Thompson, Harmar Township, PA (US)

Correspondence Address: ECKERT SEAMANS CHERIN & MELLOTT, 600 GRANT STREET, 44TH FLOOR, PITTSBURGH, PA, 15219, US

(21) Appl. No.: 10/978,174

(22) Filed: Oct. 29, 2004

Related U.S. Application Data
(60) Provisional application No. 60/515,390, filed on Oct. 29, 2003.

(51) Int. Cl. H04L 12/66

(52) U.S. Cl. 370/352; 370/521

(57) ABSTRACT

A method of optimizing packetization for a sending device of a Voice over Internet Protocol network includes encoding an audio signal, and monitoring a state of the Voice over Internet Protocol network. An optimal count of compressed data frames is determined from the state of the Voice over Internet Protocol network. The optimal count is employed to packetize the encoded audio signal in a payload. The payload is sent in a voice packet to the Voice over Internet Protocol network.

### CROSS REFERENCE TO RELATED APPLICATION

This application claims the benefit of U.S. Provisional Patent Application Ser. No. 60/515,390, filed Oct. 29, 2003.

### BACKGROUND OF THE INVENTION

1. Field of the Invention

The present invention relates to a method and apparatus for Internet telephony and, more particularly, to such a method and apparatus for minimizing end-to-end delay in a Voice over Internet Protocol (VoIP) network.

2. Background Information

Internet telephony, or voice over Internet protocol (VoIP), is one of the fastest-growing areas in communications today. IP's ability to carry traditional telephone traffic in addition to data traffic has brought attention, opportunities and challenges. An apparent benefit to people is low cost (or zero incremental cost) to make long-distance/international phone calls. In business, VoIP benefits in several aspects including new services, applications, management, etc. For instance, the integration of data and telephone networks enables new applications of unified data/voice service. It also has advantages of reduced network administration and maintenance costs. In contrast, today's VoIP still has challenges in two broad areas: standards/interoperability and quality. Standards and interoperability are very important issues to all venders and service providers. Currently, products from different venders might not be able to interoperate completely. Standard development is going on to ensure more interoperability in the near future. Quality of voice requires several parameters to be met, including acceptable levels of end-to-end delay, jitter and packet loss. The quality issue involves the network and the end point technology, at the transmitter and receiver. The IP-based network is a packet switching network that itself is the primary cause of highly variable delay and packet loss. The end point includes a number of parts that each induces a fixed delay, and the sum could add up to considerable delay. At present, VoIP in private networks can provide acceptable voice quality. This achievement has resulted from many proposals that as a whole improve the network and the end point. On the other hand, some techniques used in private networks are not applicable for VoIP in a large public network, such as the Internet. In overall, VoIP still requires more elaboration to be a mature technology.

Nowadays, voice packet delivery over the Internet still relies on the best effort service model, in which quality of service cannot be guaranteed. In terms of end-to-end delay, as a significant parameter of voice quality, the Internet causes large variable delay. Proposed network-oriented solutions for reducing end-to-end delay are the reservation protocol and differentiated service. But, these solutions have deployment problems that hinder practical implementation in today's network environment. For a given scenario, like today's Internet, it is possible that the end systems can play a role in improving end-to-end delay. Since voice encoders generate their output at a constant rate, the delivered quality of voice packet transmission is often degraded due to inadequate available bandwidth from network congestion.

VoIP is the effort to apply voice delivery over IP-based packet switching networks, including the Internet. The underlying problem is that the Internet handles all packets the same, regardless of whether they are time-sensitive voice packets or delay-tolerant data packets. In terms of quality of service, the current state of the Internet is described as best. effort service. Best effort service attempts to deliver packets through different paths regardless of incorrect sequence or packet drop. For data delivery, the TCP protocol handles end-to-end session so that any errors as well as packet drop and out-of-order packets can be recovered. Thus, this mechanism is perfectly matched to data traffic.

As a best effort service, the Internet offers no quality of service guarantee for voice delivery. Due to its time-sensitivity, voice delivery must be transported using the UDP protocol, in which no mechanism is used to handle the session. In addition, voice traffic has a constant bit rate and requires constant bandwidth. Requesting these requirements from the Internet may result in network congestion, large variable packet delay, and packet loss. In fact, voice delivery requires service that is the totally opposite of best effort service. Voice delivery needs guaranteed service, which is connection-oriented, timely, with correct sequence, and without packet drop.

At present, the Internet makes no guarantee about throughput or delay for any voice or data delivery. To provide quality of service, the structure of the Internet needs to evolve so that it can meet both data and voice traffic requirements. Two major research areas are integrated service (IntServ) and differentiated service (DiffServ). Integrated service was designed to extend the best effort model. It applies the concept of resource reservation to enable service guarantees for different types of applications. The negotiation between the application and the network is first required to request network resources. The network can either accept or reject the request. If the resource is available, the network will accept and guarantee to provide the allocated resource for that requested traffic flow. This is analogous to placing a phone call through the telephone network. Integrated service has proved that it can provide quality of service for voice delivery. However, its implementation has been limited to private networks, where components can be readily tuned together. In a large public network like the Internet, the implementation becomes an issue because of its complexity and problematic scalability.

On the other hand, the differentiated service model addresses a simple and scalable solution to support different types of applications over the Internet. It simply provides differentiation of traffic by marking individual packets with their relative priority. The network, on a hop-by-hop basis, responds to the marked packets with corresponding classified services. Differentiated service supports various types of applications by differentiate traffic based on locally generated traffic priorities. The complexity is placed at the edge network rather than the interior of the network, as in integrated service. Scalability of the implementation suggests that differentiate service will be more feasible in the next generation Internet.

The change in the Internet structure is a complicated task that requires great cooperation between venders and all ISPs. This process could take a very long time to be completed. Meanwhile, voice packet delivery still relies on the current IP model, in which quality of service cannot be met. In terms of voice packet delay, as a significant parameter of voice quality, large variable delay is still induced by the Internet. For a given scenario where the network cannot provide any service guarantee, improvements at the end point can assist to some extent. For instance, speech coding can remarkably compress voice bandwidth to as low as 6 to 8 Kbps. Voice activation detection can reduce bandwidth by one-half by not transmitting voice packets when one is listening. These bandwidth reductions affect the network. They could prevent or reduce network congestion, which would result in improved voice quality. If packet loss is induced by the network, loss concealment techniques in speech coding can help to compensate and reproduce an acceptable sound. Other techniques are possible at parts of the end point. Altogether, several techniques can be applied to increase the possibility that acceptable voice quality can be given over the Internet.

Previous studies have mentioned packetization as a part of the end-to-end delay budget. Some showed that the payload-to-overhead ratio of voice packets has an impact on network utilization. And, there is a tradeoff between packetization delay and network utilization.

A voice call consists of two IP/UDP flows with no interaction; one flow from one's voice to the other end and another voice flow for the reverse path. But, measuring unidirectional delay for a large wide area network is difficult due to the problem of clock synchronization between the two remote ends. In theory, unidirectional delays can be measured accurately by equipping each endpoint with a global positioning system (GPS) satellite transceiver, but this is an expensive solution that does not easily scale. Given this, a significant amount of study on Internet delay is still limited to round-trip delay. It is apparent that round-trip delay is asymmetric and cannot directly infer one-way delay. The studies of Internet round-trip delay, however, can provide general characteristics in short-term and long-term and trends.

Several previous studies conducted extensive measurements of Internet round-trip delay. These studies took measurements, based on ICMP and UDP, between many different remote sites for several months and at different periods of time. Their results were mostly in the same trends. In summary, delay has large variation for any given time and space, such as different remote sites. In addition, time of the day also affects the delay. For example, working hours, about 8 a.m. to 6 p.m., usually have higher delay than during the night; the delay on weekends is generally lower than weekdays. The delay has more correlation with hop count than with geographical distance because the higher delay is likely to be incurred by congestion from a large number of routers. Across several time scales, from a minute to an hour, the shape of the delay distribution is right-skewed, mostly with a mode at extreme left side and a long tail to the right. The distribution shape changes slowly over time.

FIG. 1 is an example of the distribution of Internet round-trip delay. By using the mode as the characteristic value of the distribution, it has been noted that the average period before a substantial change in the distribution is about 50 minutes. The Pareto distribution, in general, can be fit to the delay distribution. As a good trend, a long term study, measuring the delay from 1995 to 2000, showed that the delay is getting better over time. While the Internet's capacity have been upgraded over the years, even lower Internet delay is expected.

In response to the growth of multimedia traffic over packet switching networks, several standards have been proposed to work out the interoperability issues. H.323 is a standard protocol that is widely accepted. H.323 is the International Telecommunications Union's ITU-T standard that provides a broad and flexible recommendation for real-time multimedia packet-based communications. The architecture of H.323 depends on several other standards and recommendations. For voice over IP, H.323 specifies the real-time transport protocol (RTP) and the associated control protocol—real-time control protocol (RTCP)—and audio codecs such as G.711, G.729 and G.723.1. RTP/RTCP is an Internet Engineering Task Force (IETF) standard that provides the transport of real-time data over an IP network. The Internet Engineering Task Force (IETF) specified Session Initiation Protocol (SIP) competes with H.323 and does not interact with H.323.

The RTP protocol, RFC 1889, was designed to provide end-to-end transport functions suitable for real-time data such as audio or video. However, RTP itself does not provide any mechanism to ensure timely delivery or quality of services. RTP relies on lower-layer services, which control resources in routers, as well as in the sender and receiver, that utilize information provided by RTP. RTP is typically run on top of UDP to make use of its multiplexing and checksum services. The combined function of RTP and UDP is a variant of the transport layer functionality, of the OSI model, for real-time applications. The structure of a voice packet, namely an RTP packet, is shown in FIG. 2. The RTP payload is the audio data carried in RTP. The link layer header is still required, but it is not shown because it varies depending on the media in which the voice packets cross.

The format of the RTP header is shown in FIG. 3. The fixed size is typically 12 octets, and can be more if the RTP packet contains data from several sources. The version (V) identifies the version of RTP, currently version 2. If the padding (P) is set, the packet contains one or more additional padding octets at the end, which are not part of the payload. If the extension (X) is set, the fixed header is followed by exactly one header extension. The CSRC count (CC) contains the number of CSRC identifiers that follow the fixed header. The marker (M) is intended to allow significant events such as frame boundaries to be marked in the packet stream.

The key functionalities in the RTP header include payload type, sequence number and timestamp. The payload type (PT) identifies the format of the RTP payload and the encoding or compression schemes being used. The receiving application uses this information to interpret and play out the data. Default payload types are defined separate document call profiles in RFC 1890. Examples are different versions of PCM, JPEG or H261. Since UDP may deliver packets out of order, the sequence number is used by the receiver to restore packet sequence. It is also used to detect packet loss. The sequence number increments by one for each RTP packet sent. The timestamp is set at the sender to reflect the sampling instant of the first octet in the RTP packet. As an example, for fixed-rate audio, if an audio application reads blocks covering 160 sampling periods from the input device, the timestamp would be increased by 160 for each such block. The receiver uses this information to reconstruct the original timing before playing back the data. Note that timestamp is relative timing information between packets. Synchronization still needs to be done at the application level.

The synchronization source identifier (SSRC) identifies the synchronization source. This identifier is chosen randomly to prevent collisions, in which two synchronization sources in the same RTP session have the same SSRC identifier. The contributing source identifier (CSRC) is optional. It identifies the contributing sources in the payload of RTP packet. The number of identifiers is given by the CC field.

To augment the RTP protocol, the real-time control protocol (RTCP) can be used to monitor packet delivery and to provide minimal control and identification functionality. RTCP is transmitted periodically to its participants in the session, by using a separate UDP port number. Its primary function is to provide feedback on the quality of packet delivery. This may be useful for other control functions to adapt to different network congestion.

Speech coding, and decoding, is an important component in the process of voice over IP. It samples and digitizes voice into a digital form for packet transmission. Pulse Code Modulation (PCM) is a coding scheme that has been used for decades in the digital PSTN. PCM requires bandwidth of 64 Kbps for a voice channel, and no compression. In the VoIP environment, PCM consumes too much bandwidth and does not utilize bandwidth efficiently. Fortunately, several speech codings with compression techniques are now available and make voice over IP more practical. These codings are capable of compressing traditional 64 Kbps of PCM to as low as 6 to 8 Kbps.

In general, speech coding can be classified into 3 types: waveform coding, vocoding and hybrid coding. The primary objective of waveform coding/decoding is reproducing the analog input waveform as accurately as possible. The waveform coding assumes no knowledge of the nature of the signal it is processing. Examples of waveform coding include PCM and ADPCM. Vocoding, namely voice coding, is designed specifically for voice signals. Its basic goal is to build a set of parameters, which are perceptual parts of speech, and send them to the receiver. The receiver uses these parameters to drive a speech production model. This scheme apparently requires fewer bits than waveform coding. Linear prediction coding (LPC) is an example. However, vocoding cannot reproduce an adequate quality of voice. The reproduced sound might be like synthetic voice. Numerous techniques have been developed to solve this shortcoming. Several schemes are in the category of hybrid coding, which combine effective features of waveform coding and vocoding. Hybrid coding can, at the same time, provide acceptable quality of voice and at a very low bandwidth. The examples are code-excited linear prediction (CELP) and multi-pulse, multi-level quantization (MP-MLQ).

Typically, we refer to a speech coding by its standard. Speech coding techniques are standardized by ITU-T in the G-series recommendations. The most widely used coding standards for telephony and voice packet are:
G.711. Standard for PCM speech coding that provides toll quality audio at 64 Kbps.
G.726. Standard for adaptive differential PCM (ADPCM). Depending on its bit samples (2, 3, 4 or 5), the compressed bandwidth is at 16, 24, 32 or 40, respectively. 32-kbps ADPCM is commonly used.
G.721. Similar to G.726, it provides compressed bandwidth at 32 Kbps using ADPCM.
G.728. Standard for low-delay variation of CELP (LD-CELP). The compressed bandwidth is at 16 Kbps.
G.729. Standard for conjugate-structure algebraic-code-excited linear prediction (CS-ACELP) that provides compressed bandwidth at 8 Kbps. Two variations are G.729 and G.729 Annex A. They differ mainly in computational complexity.
G.723.1. Standard for speech coding optimized for modems. The compressed audio is at 6.3 Kbps, using MP-MLQ and at 5.3 Kbps, using ACELP. (This standard number has an extension (0.1) because the numbers in G series have been used already.)

Today, most speech codings deployed for voice over IP are the hybrid type because of its low bandwidth requirement. However, low bandwidth consumption is not the only requirement. Speech codings affect other significant factors as well and they need to be considered. Two major factors are voice quality and coding delay. Different codings require varying time to process the coding/decoding and result in a certain level of voice quality. For instance, since PCM has no compression, it has the best voice quality and processing time. Since voice quality is a subjective response of the listener, a common benchmark used to determine the sound produced by specific codings is the mean opinion score (MOS). With MOS, a wide range of listeners judge the quality of voice sample on a scale of 1 (bad) to 5 (excellent). The scores are averaged to provide the mean opinion score. Table 2-1 compares parameters of different speech codings.

TABLE 1

| | | | | | Coding |
|---|---|---|---|---|---|
| | | Bandwidth | | | delay |
| Standard | Coding | (Kbps) | MOS | Complexity | (ms) |
| G.711 | PCM | 64 | 4.3 | 1 | 0.125 |
| G.726 | ADPCM | 32 | 4.0 | 10 | 0.125 |
| G.728 | LD-CELP | 16 | 4.0 | 50 | 0.625 |
| G.729 | CS- | 8 | 4.0 | 30 | 15 |
| | ACELP | | | | |
| G.729A | | | | 15 | |
| G.723.1 | MP-MLQ | 6.3 | 3.8 | 25 | 37.5 |
| | ACELP | 5.3 | | | |

The speech coding delay is a significant factor that could affect the limited-budget end-to-end delay. From Table 1, the coding delay is the sum of voice frame delay, processing delay and look-ahead delay. The voice frame delay is the smallest voice signal unit in time needed by the DSP chip to generate one compressed data frame. The processing delay is the actual time spent in the coding algorithm. The processing delay is typically very small and depends on the coding complexity and the speed of hardware, such as processor and RAM. Since vocoding takes advantage of the close correlation between successive voice frames, the look-ahead is incurred by examining a certain amount of the next voice frame.

Unidirectional end-to-end delay is one of the most important considerations in implementing voice over IP. The G.114 ITU-T standard describes that a 150-milliseconds one-way delay is acceptable for high voice quality. The traditional PSTN does not have a delay problem because, after the connection is established, the voice channel is dedicated. Calls on the PSTN usually exhibit delay from 50 to 70 milliseconds. Unlike the PSTN, each step of VoIP adds some amount of delay and the sum could add up to 500 milliseconds. It can be said that voice over IP has a delay budget of 150 milliseconds. The challenge is how to minimize delay in a certain part or allocate the appropriate delay into parts so that the overall end-to-end delay is within budget and is as low as possible.

The speech coding part helps to reduce the bandwidth requirement; however, it adds more delay. In practice, several parts of VoIP tradeoff against end-to-end delay. Thus, it is really necessary to understand each step of VoIP and its associated induced delay.

FIG. 4 shows a simple VoIP data flow, after signaling for establishing a session is completed. First, at the sender, the audio signal is encoded by a certain coding scheme. This step includes sampling, digitizing, companding and coding. The delay incurred can be referred to the previous section. The result of the coding is a compressed data frame in bytes. The coding process is typically performed by a ESP chip. Because a run of the process generates one data frame, the sender can be set to wait for many data frames and then it transmits them together. The packetization step collects a number of the data frames into the payload and prepares all the necessary headers (IP, UDP and RTP) to form a voice packet. The delay of this step is equal to the total amount of time needed to generate a certain number of data frames, which will be packed into the same payload. For instance, the G.729 standard needs 10-millisecond voice frame delay and 5-millisecond look-ahead delay to generate one data frame of 10 bytes. If two data frames are required in a payload, the packetization delay is 25 milliseconds (2 of 10-millisecond voice frame and 5-millisecond of look-ahead).

Transmission delay occurs when the packet is transmitted. Transmission, or serialization, delay is the time required to transmit all of the packet's bits into the link. It is a constant function of link speed and packet size. For example, a voice packet containing two G.729 voice frames has size equal to 60 bytes. If the link speed is 256 Kbps, the transmission delay is 1.875 milliseconds. Transmission delay is practically less than a couple of milliseconds. However, this delay occurs every time a packet is transmitted to the link. The more router-hops the packet goes across, the more total transmission delay adds up.

Packets may be stored in the queue before being transmitted to the link. This happens when many packets arrive at a router at the same time, while the link can transmit one packet at a time. The waiting time in the queue is called queuing delay. If the sender is the end point, it may not have queuing delay because no bursty data traffic passes through, thus the link can handle the transmitting packets without building up the queue. Every router usually induces queuing delay since it handles large amount of bursty traffic. Queuing delay of a given packet varies significantly from packet to packet. If the queue is empty, the queuing delay can be zero. On the other hand, if there are a lot of packets in the queue waiting to be transmitted, the given packet might experience very long queuing delay. Packet arrival behavior at the router, load condition, and link capacity are significant factors that affect the queuing delay. In practice, when packets pass through several hops in a whole network, it would be even harder to determine the varying queuing delay. Therefore, characterizing queuing delay is usually done by statistical measures, such as average queuing delay, variation of queuing delay and the probability of some specific value.

Every router requires some time to examine the packet's header and determine where to direct the packet. This action causes a small delay called processing delay. Processing delay is typically on the order of microseconds or less, especially in high-speed routers. After a packet is processed, it is directed to the appropriate queue and waits to be transmitted.

Once a packet is transmitted on the link, its digital signal propagates to the next router hop. The time required for the propagation is called propagation delay. Digital signals propagate at the propagation speed of the link. The propagation speed depends on physical medium of the link. Typical media are copper wire or optical fiber, which has a speed around 2 to 3×10⁸ meters per second. By a simple calculation, propagation delay ranges from 3.3 to 5 microseconds per kilometer. Therefore, propagation delay depends on the overall physical distance between the sender and receiver.

Due to the high variation of queuing delay, the inter-arrival time between consecutive voice packets at the receiver is not constant. Since a constant rate of decoded voice is required for playing back, a jitter buffer (or playout buffer) is normally used. The function of jitter buffer is that early arriving packets are buffered and wait for the late arriving packets so that all of them can be played out at a constant rate. Since arriving packets are not played out immediately, the waiting time in the jitter buffer, called jitter buffer delay, could add more delay to the budget. The packet's RTP header will be used by the receiver to help re-order packets and arrange for appropriate playout. In practice, a jitter buffer can be implemented as fixed or adaptive type. The adaptive jitter buffer uses an algorithm to adjust its size so that it is able to respond to the current jitter level accordingly. This method can help to reduce the delay caused by jitter buffer. Finally, the last step is decoding the packet's payload, and then playing back the voice. Decoding delay is usually less than the corresponding encoding delay and depends on the coding complexity and hardware speed.

In summary, the delays of VoIP described above can be classified into two categories. Fixed delays include coding delay, packetization delay, transmission delay, processing delay and propagation delay. Variable delay, changing over time, is queuing delay. Jitter buffer delay can be fixed or variable, depending on its type. For better voice quality, development in any parts can contribute to lower end-to-end delay. The primary parameters are coding delay, packetization delay, queuing delay and jitter buffer delay. Furthermore, dealing with delays in voice over IP is actually more complicated than one would expect. Delay parameters have inherent trade-offs against voice quality, bandwidth requirement, end-to-end delay and packet loss. Improvement techniques and appropriate allocation of delays need to be investigated altogether for better quality of voice.

### SUMMARY OF THE INVENTION

These needs and others are satisfied by the present invention, which provides that for a certain network load, there is an optimal packetization that allows minimal end-to-end delay. This solution equips the sender with adaptive packetization. This enables the sender to transmit voice packets adaptively in different rates, using any constant rate voice encoder. By performing adaptive rate control, the sender can detect the state of the network and adjust its transmission rate. Thereby, the sender can avoid network congestion and reduce (even, minimize) end-to-end delay.

The focus is on packetization at the transmitter of voice packets. Packetization is collecting a number of compressed voice data bytes into the payload of the voice packet. Packetization causes some amount of fixed delay, which is proportional to the size of voice packet. Other effects of packetization are also interesting. Packetization is indirectly associated with the bandwidth requirement of voice traffic, which could also relate to network congestion and induced variable network delay. The present invention considers how packetization can affect end-to-end delay of a voice flow. The relation between packetization delay and end-to-end delay shows that a tradeoff is key to minimize end-to-end delay. The optimal packetization delay can result in the possible lowest end-to-end delay of a voice flow.

As one aspect of the invention, a method of optimizing packetization for a sending device of a Voice over Internet Protocol network comprises: encoding an audio signal; monitoring a state of the Voice over Internet Protocol network; determining an optimal count of compressed data frames from the state of the Voice over Internet Protocol network; employing the optimal count to packetize the encoded audio signal in a payload; and sending the payload to the Voice over Internet Protocol network.

The method may include determining the optimal count of compressed data frames during set-up of a Voice over Internet Protocol call.

The method may include determining the optimal count of compressed data frames in real-time periodically during a Voice over Internet Protocol call.

The method may include adjusting the optimal count of compressed data frames.

As another aspect of the invention, a sending device for a Voice over Internet Protocol network comprises: an encoder inputting an audio signal and outputting an encoded audio signal; a first circuit monitoring a state of the Voice over Internet Protocol network; a second circuit determining an optimal count of compressed data frames from the state of the Voice over Internet Protocol network; a third circuit employing the optimal count to packetize the encoded audio signal in a payload; and a fourth circuit sending the payload to the Voice over Internet Protocol network.

As another aspect of the invention, a Voice over Internet Protocol communication system comprises: a Voice over Internet Protocol network; a sending device comprising: an encoder inputting an audio signal and outputting an encoded audio signal, a first circuit monitoring a state of the Voice over Internet Protocol network, a second circuit determining an optimal count of compressed data frames from the state of the Voice over Internet Protocol network, a third circuit employing the optimal count to packetize the encoded audio signal in a payload, and a fourth circuit sending the payload to the Voice over Internet Protocol network; and a receiving device receiving the payload from the Voice over Internet Protocol network.

### BRIEF DESCRIPTION OF THE DRAWINGS

A full understanding of the invention can be gained from the following description of the preferred embodiments when read in conjunction with the accompanying drawings in which:

FIG. 1 is a plot showing the distribution of Internet round trip delay.

FIG. 2 is a block diagram showing the structure of a voice packet.

FIG. 3 is a block diagram showing the format of the RTP header.

FIG. 4 is a block diagram showing a simple VoIP data flow.

FIG. 5 is a block diagram of the model used in the study.

FIG. 6 is a plot showing bandwidth requirements for G.711 as a function of packetization.

FIG. 7 is a plot showing bandwidth requirements for G.726 as a function of packetization.

FIG. 8 is a plot showing bandwidth requirements for G.729 as a function of packetization.

FIG. 9 is a plot showing queuing delay of an M/M/1 queuing system.

FIG. 10 is a plot showing the inherent tradeoff of packetization delay.

FIG. 11 is a plot showing packetization delay and queuing delay at different network loads.

FIG. 12 is a plot showing end-to-end delay as a function of packetization and network load.

FIG. 13 is a plot showing analytical results for the G.711 standard.

FIG. 14 is a plot showing analytical results for the G.726 standard.

FIG. 15 is a plot showing analytical results for the G.729 standard.

FIG. 16 is a block diagram of the experiment setup.

FIG. 17A is a plot showing packet delay in time domain at a packetization delay of 10 milliseconds.

FIG. 17B is a plot showing packet delay in time domain at a packetization delay of 20 milliseconds.

FIG. 17C is a plot showing packet delay in time domain at a packetization delay of 30 milliseconds.

FIG. 17D is a plot showing packet delay in time domain at a packetization delay of 40 milliseconds.

FIG. 18A is a plot showing a probability density function of network delay at a packetization delay of 10 ms.

FIG. 18B is a plot showing a probability density function of network delay at a packetization delay of 20 ms.

FIG. 18C is a plot showing a probability density function of network delay at a packetization delay of 30 ms.

FIG. 18D is a plot showing a probability density function of network delay at a packetization delay of 40 ms.

FIG. 19 is a plot showing overall measurement results compared to analytical results at CIF of network delay at different packetization delay.

FIG. 20 is a plot showing overall measurement results compared to analytical results at CIF of end-to-end delay at different packetization delay.

FIG. 21A is a plot showing overall measurement results compared to analytical results at 85 percent offered load.

FIG. 21B is a plot showing overall measurement results compared to analytical results at 80 percent offered load.

FIG. 21C is a plot showing overall measurement results compared to analytical results at 70 percent offered load.

FIG. 21D is a plot showing overall measurement results compared to analytical results at 60 percent offered load.

FIG. 22 is a block diagram of a VoIP sender employing adaptive packetization.

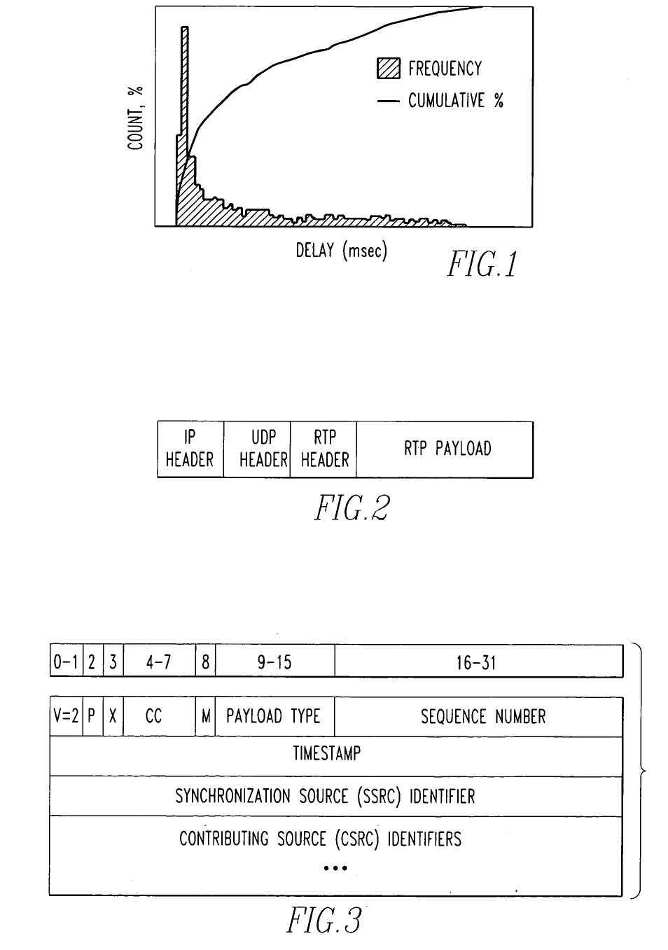

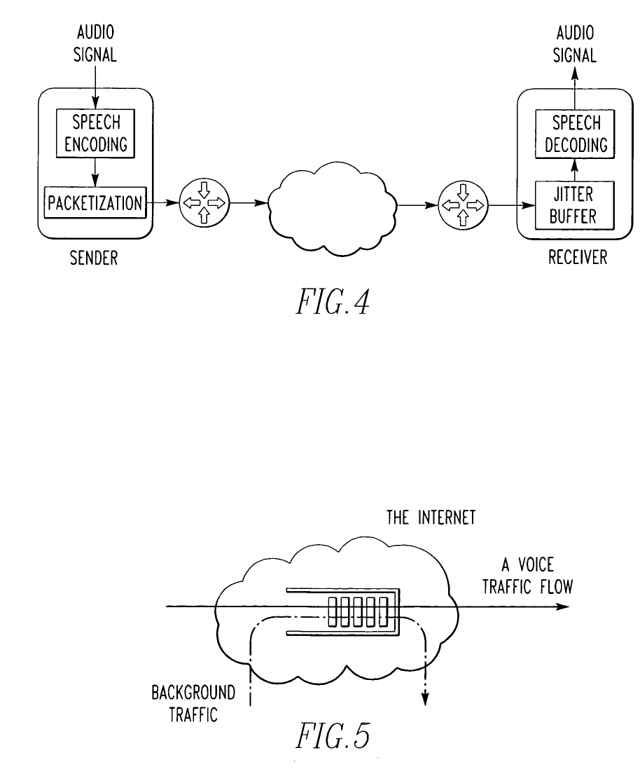

### DESCRIPTION OF THE PREFERRED EMBODIMENTS

The methodology consists of an analytical part and an experimental part. A simple Internet model is created, in which a voice call is established across the model. Queuing theory is applied to study the effects of packetization delay. Two factors are different levels of packetization delay and network load. By varying factors, the measurement records voice packet delays. In the conclusion, the results from both parts are compared.

In order to study voice quality for VoIP over the Internet, knowledge of Internet delay characteristics is necessary. This information permits the determination of the most effective techniques to reduce delays of voice packets. For VoIP, Internet round-trip delay is not as interesting and beneficial as unidirectional delay. This is because voice packets have time-sensitive requirements and no acknowledgement or retransmission is necessary.

Packetization impacts on parts of the bandwidth requirement. These are comprised of overhead bandwidth, effective voice bandwidth and the total network bandwidth. Queuing theory shows how end-to-end delay is affected by packetization delay and network load. Finally, the optimal packetization delay is determined in order that end-to-end delay can be minimized.

A model represents best-effort Internet service. A voice call is established across the model, but background traffic shares the same links as the voice flow to form different network load conditions. The model is shown in FIG. 5. The cloud represents the Internet network. It has an inherent delay characteristic as the Pareto distribution. This characteristic is chosen in correspondence with reference studies of Internet delay. A. Acharya and J. Saltz, “A study of Internet Round-trip Delay”, http://www.cs.umd.edu/˜acha/papers/latency-tr.html; L. Cottrell, Stanford Linear Accelerator Center, http://www.slac.stanford.edu/comp/net/net.html; T. J. Kostas, M. S. Borella, I. Sidhu, G. M. Schuster, J. Grabiec, and J. Mahler, “Real-Time Voice Over Packet-Switched Networks”, IEEE Network, January/February 1998.

Most average Internet round-trip delays are within a range of 70 to 180 milliseconds. In general, it varies depending on links and time of the day. For a given space and time, the model assumes a one-way average inherent delay of 70 milliseconds and a standard deviation of 10 milliseconds. Further, the model assumes that no considerable change of the delay characteristic takes place during the voice call. Packet drop inside the model is not considered. The voice call is only considered in a given one-way traffic flow, in which the voice of a speaker is transmitted to the listener. This is due to the fact that two flows, voice transmitted and voice received, of a VoIP session experience different network congestions and result in different network delay. For simplicity of the analysis, the voice call traffic is assumed to be a constant bit rate in which techniques, such as voice activation detection, are not applied.

In general, the structure of the Internet comprises thousands of hierarchical networks: the core, intermediate and access networks. The core and intermediate networks are efficiently capable of switching traffic flows and managing network congestion. Besides, they provide high-speed link capacity. Whereas link capacity of access networks is usually low-speed, it is common that access networks could cause network congestion to voice flows. The queue in the model represents the weakest network link, essentially in the access network that a voice call must cross. Hence, link capacity is assumed to be 256 Kbps as the bottleneck. Considering data traffic, it consumes extensive bandwidth but it bursts for a very short period of time. Voice traffic, in contrast, requires high volume of bandwidth (10 to 40 Kbps) that lasts continuously for several minutes, the whole duration of the call. Voice traffic contributes heavily to network congestion due to its continuously large bandwidth requirement. Also, voice traffic is based on the UDP protocol that just transmits voice packets without any session control mechanism. The constant network bandwidth required by a voice flow would easily raise network load and results in increasing network delay to the voice flow itself. The background traffic that shares the same queue as the voice flow is modeled as a Poisson arrival. It is assumed to be traditional data traffic and it adds to the network load.

One important issue in a packet switching network is the amount of network bandwidth required for the headers of the packets. Data packet delivery is not much affected by this issue because the payload size can be increased so the payload-to-overhead ratio remains high. In voice packet delivery, packetization collects a number of compressed voice data bytes into the payload of a voice packet. In other words, packetization determines the payload size. Due to the time-sensitive characteristic of the voice packets, packetization delay needs to be small so that it does not induce increased end-to-end delay. The payload-to-overhead ratio becomes a significant issue for voice packet delivery because the ratio is normally about fifty percent. This means that, in order to have voice packet delivery, the bandwidth required for all the overhead is about two times the effective voice bandwidth. The total network bandwidth requirement, which is the sum of overhead bandwidth and effective voice bandwidth, is then about three times the voice bandwidth.

TABLE 2

| | | | | Size of |
|---|---|---|---|---|
| | | Effective | | compressed |
| | | bandwidth | Voice frame | data frame |
| Standard | Coding | (Kbps) | delay (ms) | (bits) |
| G.711 | PCM | 64 | 0.125 | 8 |
| G.726 | ADPCM | 32 | 0.125 | 4 |
| G.729 | CS-ACELP | 8 | 10 | 80 |

Bandwidth requirements can be determined from the size of header and payload. For VoIP, the packet header is at least 40 bytes, which includes a 20-byte IP header, an 8-byte UDP header and a 12-byte RTP header. The link-layer header is usually not considered because it varies as the packet travels across physical networks. The payload size is determined from packetization, where packetization causes some amount of fixed delay. Thus, the trade-off between packetization delay and bandwidth occurs. The delay caused by packetization depends on speech coding techniques. Table 2 shows some important parameters needed for the bandwidth requirement calculation. The voice frame delay is the smallest voice signal unit in time needed by the DSP chip to generate one compressed data frame. The size of the compressed data frame is the smallest data in bytes as a result of a voice frame compressed by a certain speech coding scheme. For instance, the G.729 standard requires 10 milliseconds of voice signal to generate a 10-byte compressed data frame. Packetization collects several of these compressed data frames and places into the same payload. The relationship between packetization and bandwidth requirements, as a function of the number of compressed data frames in payload, can be shown as the following equations.

$$\begin{matrix}The effective ( compressed ) voice bandwidth = \frac{f}{{t}_{p}} Kbps & ( Eq . 1 ) \\ The overhead bandwidth = \frac{h}{{Nt}_{p}} Kbps & ( Eq . 2 ) \\ The network bandwidth = \frac{1}{N} [ \frac{h + Nf}{{t}_{p}} ] Kbps & ( Eq . 3 )\end{matrix}$$

Wherein:
tₚ is Voice frame delay (ms);
f is Size of compressed data (bit);
N is The number of compressed data frames in payload; and
h is Header size of voice packet (bit).

Equation 1 is the effective voice bandwidth as it is compressed by speech coding. It represents the actual bandwidth needed to transmit. The overhead bandwidth can also be determined by subtracting the network bandwidth (Equation 3) by the effective bandwidth (Equation 1).

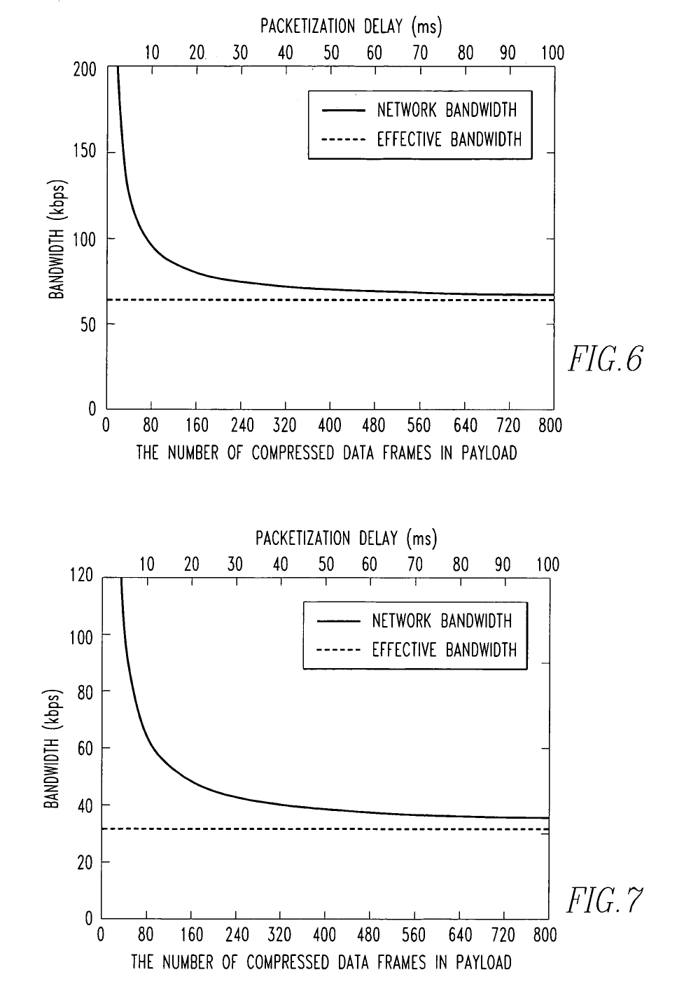

FIGS. 6, 7 and 8 show the plots of the G.711, G.726 and G.729 standards respectively. The bottom horizontal scale is the number of compressed data frames in the payload. The upper horizontal scale shows the corresponding packetization delay of the bottom scale, which is the product of voice frame delay and the number of compressed data frame. Each plot has the same decreasing exponential curve. At very small payload, the network bandwidth requirement is extremely large. The gap between the network and effective bandwidth curve is the overhead bandwidth. Notice that, for any speech coding, the same packetization delay results in the same overhead bandwidth requirement. This is because the size of packet overhead is constant, no matter which speech coding is used.

The G.711 standard has no compression. From FIG. 6, the effective bandwidth is 64 Kbps as used in traditional telephone network. One byte of the compressed data frame is generated every 0.125 milliseconds. It can be seen that the payload size below 80 bytes is not practical because of huge network bandwidth requirement. Around 80 to 320 bytes, the bandwidth requirement is below 100 Kbps and the packetization delay is less than 40 milliseconds, which is reasonable enough for practical use. The G.726 standard examined in this analysis uses 4-bit samples. So, packing a byte of payload requires two compressed data frames and causes 0.25 milliseconds of delay. From FIG. 7, the payload size around 40 to 160 bytes has reasonable network bandwidth and packetization delay. From FIG. 8, the G.729 standard's effective bandwidth is 8 Kbps. One compressed data frame is 10 bytes in size and causes 10-millisecond delay. The payload-to-overhead ratio is very low at the payload size of 10 and 20 bytes. However, any of the payload sizes seems feasible since the largest network bandwidth required for the G.729 standard is 40 Kbps. Comparing these 3 speech codings, as the compression produces lower effective bandwidth, more bandwidth is available for overhead bandwidth (for a given bandwidth capacity). If overhead bandwidth could be compressed, more efficiency would be available for voice packet delivery.

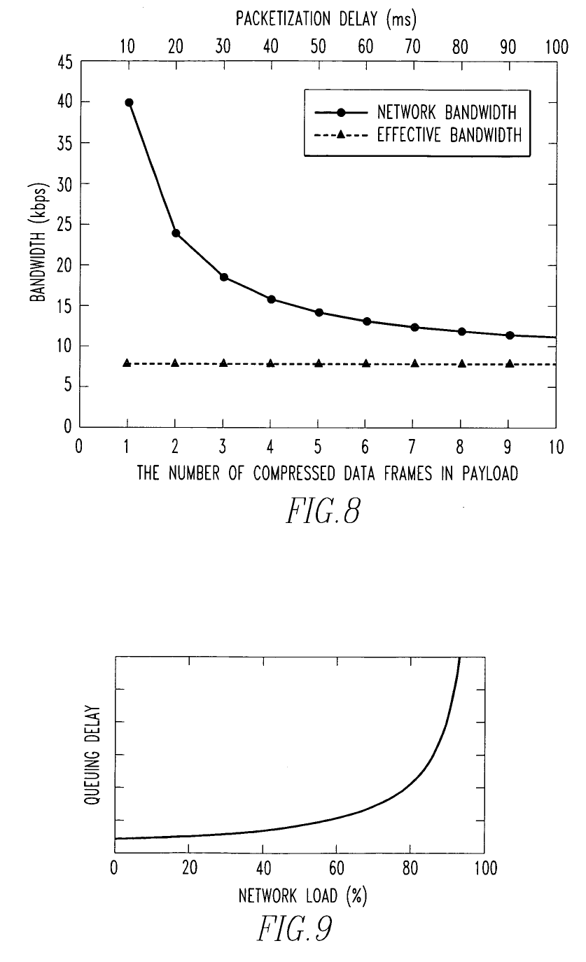

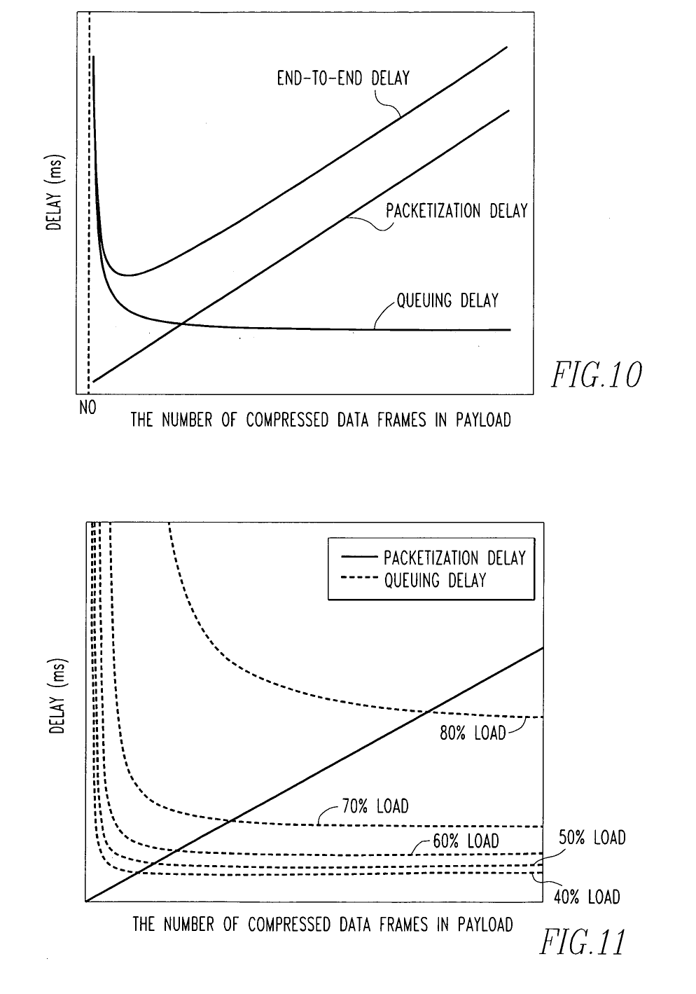

There is a trade-off between packetization delay and bandwidth requirements. Large bandwidth requirements for voice packet delivery could simply affect network congestion and, then, end-to-end delay. Further, determining the relationship between packetization delay and end-to-end delay is so interesting that one may allocate the delay budget into parts of the VoIP process properly. For an illustrated example, consider two voice flows, which use the same G.729 speech coding but different packetization delay. Flow A uses 40-millisecond packetization delay, thus it requires 16-kbps network bandwidth. Flow B uses 20-millisecond packetization delay, and the bandwidth required is 24 Kbps. Suppose each flow passes through a simple M/M/1 queuing system. The typical queuing delay caused by the queue is shown in FIG. 9. Suppose flow A causes total network load equal to 80 percent but flow B (which requires more bandwidth than flow A) causes total network load equal to 90 percent. End-to-end delay is simply the sum of packetization delay and queuing delay. At this situation, flow A would have much lower end-to-end delay than flow B. The larger bandwidth required by flow B induces huge queuing delay and results in high end-to-end delay. On the other hand, suppose flow A causes total load equal to 40 percent but flow B causes total load equal to 50 percent. Here, the bandwidth required by flow B induces just slightly greater queuing delay. In conclusion, both packetization delay and current network load condition affect on end-to-end delay.

The relationship between packetization delay and end-to-end delay is first determined. This assumes that end-to-end delay is the sum of packetization delay and queuing delay. Other fixed delays, which depend on their factors, can be added later. According to the model, total traffic consists of a Poisson arrival flow of background traffic and a deterministic voice flow. Even if the queue treats voice traffic differently from data traffic, the model is assumed to be an M/M/1 queuing system because the majority of the load is from the background traffic. The average queuing delay (T_{q}), at current load p percent, is the sum of waiting time in the queue (T_{w}) and service time of the queue (Tₛ), which can be written as

$$\begin{matrix}{T}_{q} = {T}_{w} + {T}_{s} msec & ( Eq . 4 ) \\ where & \\ {T}_{w} = \frac{ρ {T}_{s}}{1 - ρ} msec & ( Eq . 5 )\end{matrix}$$

When the voice flow is established across the link, its network bandwidth consumption (Δ) raises the network load. Then, the total network load is

$${ρ}_{total} = ρ + \frac{Δ}{c} \qquad ( Eq . 6 )$$

where c is link capacity of the queue. From Equation, 3, the network bandwidth required by a voice flow (Δ) is known. Hence,

$${ρ}_{total} = ρ + \frac{1}{cN} [ \frac{h + Nf}{{t}_{p}} ] \qquad ( Eq . 7 )$$

Considering the waiting time in Equation 5, it is caused by the background and voice traffic. This gives

$${T}_{w} = \frac{ρ ( \frac{p}{c} )}{1 - {ρ}_{total}} + \frac{( \frac{Δ}{c} ) ( \frac{h + Nf}{c} )}{1 - {ρ}_{total}} msec \qquad ( Eq . 8 )$$

where p is the average packet size of background traffic. From Equation 4, the average queuing delay is the sum of the waiting time in Equation 8 and the service time of the voice flow. Therefore,

$${T}_{q} = \frac{ρ ( \frac{p}{c} )}{1 - {ρ}_{total}} + \frac{( \frac{Δ}{c} ) ( \frac{h + Nf}{c} )}{1 - {ρ}_{total}} + ( \frac{h + Nf}{c} ) msec \qquad ( Eq . 9 )$$

The other part of end-to-end delay, the packetization delay is proportional to the number of compressed data frames in payload, which is
Tₚ=Ntₚ msec (Eq. 10)
Finally, the average end-to-end delay is

$$D = {Nt}_{p} + \frac{ρ ( \frac{p}{c} )}{1 - {ρ}_{total}} + \frac{( \frac{Δ}{c} ) ( \frac{h + Nf}{c} )}{1 - {ρ}_{total}} + ( \frac{h + Nf}{c} ) msec \qquad ( Eq . 11 )$$

Or, by substituting ρₜₒₜₐₗ, from Equation 7 and Δ from Equation 3, we have

$$\begin{matrix}D = {Nt}_{p} + \frac{ρ ( \frac{p}{c} )}{1 - ( ρ + \frac{1}{cN} [ \frac{h + Nf}{{t}_{p}} ] )} + \\ \frac{( \frac{1}{cN} [ \frac{h + Nf}{{t}_{p}} ] ) ( \frac{h + Nf}{c} )}{1 - ( ρ + \frac{1}{cN} [ \frac{h + Nf}{{t}_{p}} ] )} + ( \frac{h + Nf}{c} ) msec\end{matrix} \qquad ( Eq . 12 )$$

It is difficult to present relationships from Equation 12. A simplified version can be determined if it is assumed that all service time (Tₛ) used in the analysis is equal to the average packet size of background traffic (p) divided by link capacity of the queue (c). This will give the queuing delay as an upper bound. Hence, Equation 8 can be rewritten as

$${T}_{w} = \frac{{ρ}_{total} ( \frac{p}{c} )}{1 - {ρ}_{total}} msec \qquad ( Eq . 13 )$$

Substituting Equation 13 in Equation 4 gives

$${T}_{q} = \frac{{ρ}_{total} ( \frac{p}{c} )}{1 - {ρ}_{total}} + \frac{p}{c} = \frac{( \frac{p}{c} )}{1 - {ρ}_{total}} msec \qquad ( Eq . 14 )$$

Therefore, the average end-to-end delay is

$$D = {Nt}_{p} + \frac{( \frac{p}{c} )}{1 - {ρ}_{total}} = {Nt}_{p} + {\frac{( \frac{p}{c} )}{1 - ( ρ + \frac{1}{cN} [ \frac{h + Nf}{{t}_{p}} ] )}}_{m sec} \qquad ( Eq . 15 )$$

Equation 15 shows that decreasing N results in decreasing packetization delay in the first term but increasing queuing delay in the second term. The trade-off is illustrated. The plot of this equation is shown in FIG. 10.

FIG. 10 has no scale that is generalized for any speech codings. Delays are a function of the number of compressed data frames in payload. The packetization delay and queuing delay curve is from Equation 15's first and second terms, respectively. The end-to-end delay is the sum of these two curves. There is only a small range of N that allows very low end-to-end delay. At a very small N, the queuing delay tremendously affects end-to-end delay. To the right of the convex point, the packetization delay gradually increases end-to-end delay.

The optimal number of compressed data frames in payload that allows lowest end-to-end delay can be determined by differentiating Equation 15 and setting equal to zero, as follows. Simplifying Equation 15 gives

$$D = {Nt}_{p} + \frac{{pt}_{p} N}{N ( {ct}_{p} ( 1 - ρ ) - f ) - h} \qquad ( Eq . 16 )$$

Let
A=ptₚ and B=ctₚ(1−ρ)−f
Equation 16 can be written as

$$\begin{matrix}D = {Nt}_{p} + \frac{AN}{BN - h} & ( Eq . 16 A ) \\ \frac{ⅆ D}{ⅆ N} = {t}_{p} + \frac{A ( BN - h ) - BAN}{{( BN - h )}^{2}} = 0 & ( Eq . 16 B ) \\ {t}_{p} + \frac{- Ah}{{( BN - h )}^{2}} = 0 & ( Eq . 16 C ) \\ N = \frac{1}{B} [ \sqrt{\frac{Ah}{{t}_{p}}} + h ] & ( Eq . 16 D )\end{matrix}$$

Therefore, the optimal number of compressed data frames in a payload

$${N}_{opt} = \frac{h + \sqrt{ph}}{{ct}_{p} ( 1 - ρ ) - f} \qquad ( Eq . 17 )$$

The corresponding optimal packetization delay is

$${T}_{p opt} = {N}_{opt} {t}_{p} = \frac{{t}_{p} ( h + \sqrt{ph}}{{ct}_{p} ( 1 - ρ ) - f} m sec \qquad ( Eq . 18 )$$

By rearranging terms in Equation 17, a perceivable form of Nₒₚₜ can be written as

$${N}_{opt} = \frac{( \frac{h + \sqrt{ph}}{{t}_{p}} )}{c ( 1 - ρ ) - \frac{f}{{t}_{p}}} \qquad ( Eq . 19 )$$

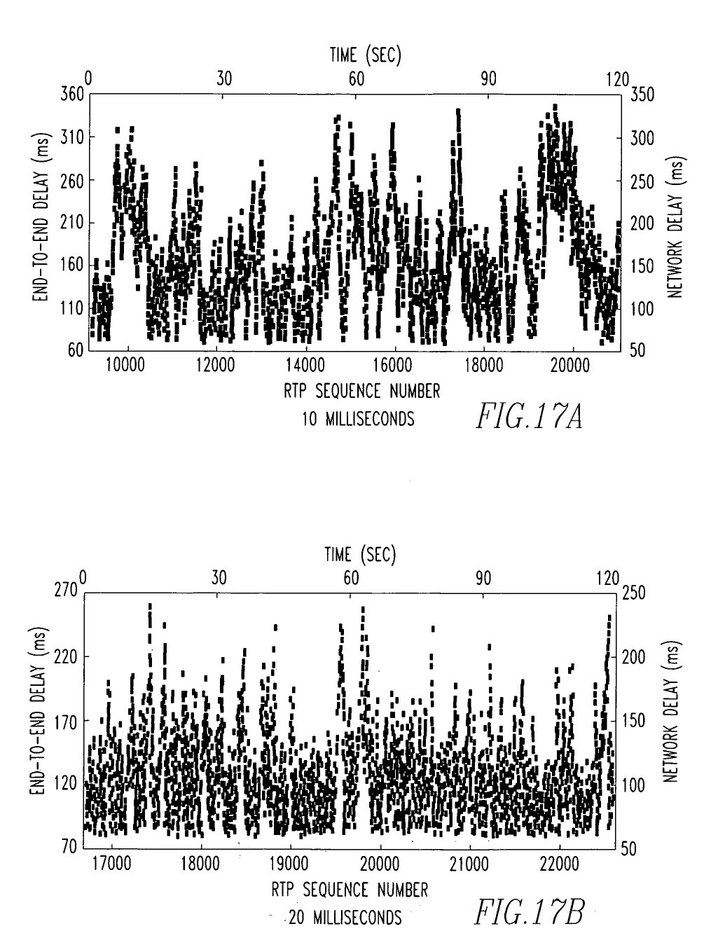

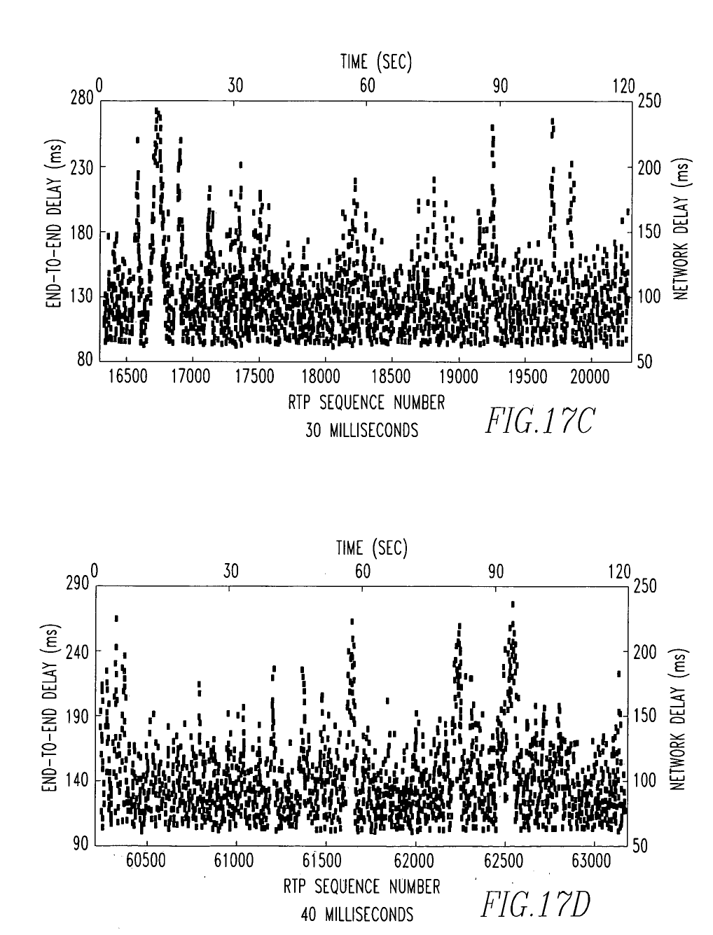

The term c(1−ρ) is the available bandwidth for voice traffic, as a function of network load. The term f/tₚ is the compressed voice bandwidth as shown in Equation 1. Thus, the denominator is the available bandwidth for the overhead of voice traffic. It can be seen that Nₒₚₜ is reversely proportional to the overhead bandwidth. If large overhead bandwidth is available, Nₒₚₜ can be very small. On the other hand, if small overhand bandwidth is available, larger Nₒₚₜ is needed. Note that a more accurate Nₒₚₜ can also be determined by differentiating Equation 12 and setting equal to zero. However, the result in Equation 17 is much simpler and understandable. The difference by using the average end-to-end delay equation in Equations 12 and 15 is discussed below in connection with FIGS. 17A-21D.

From FIG. 10, the queuing delay curve starts after a minimum number (N₀) of frames in a payload, called as the breakout point. At this point, the payload size of voice packet is so small that the packet rate consumes so much network bandwidth that causes infinite queuing delay. From Equation 14, N₀ is the condition where the divider is equal to zero. Hence,

$${N}_{0} = \frac{h}{{ct}_{p} ( 1 - ρ ) - f} ; {N}_{0} \geq 1 \qquad ( Eq . 20 )$$

Therefore, packetization must be greater than N₀ to avoid infinite queuing delay. In fact, networks become impractical before the load reaches hundred percent. In practice, N₀ can be rewritten as

$${N}_{0} = \frac{h}{{ct}_{p} ( x - ρ ) - f} \qquad ( Eq . 21 )$$

where x, 0<x<1, is the maximum sustainable level of network load.

From Equation 14, the status of network load is another factor that can affect queuing delay. While packetization delay has an impact on increased network load, the network load itself changes over time. Thus, end-to-end delay is highly variable in general. From Equation 6, the amount that the voice's network bandwidth increases queuing delay depends on the capacity of the weakest network link. For the Internet network, these parameters are unknown and it is hard to predict end-to-end delay. For instance, if the current network load is small, the increase in queuing delay caused by the voice flow could be small. On the other hand, if the link is near capacity, the increase in bandwidth could cause network overload, and high queuing delay. In private networks, where parameters can be determined, this knowledge can aid network planning.

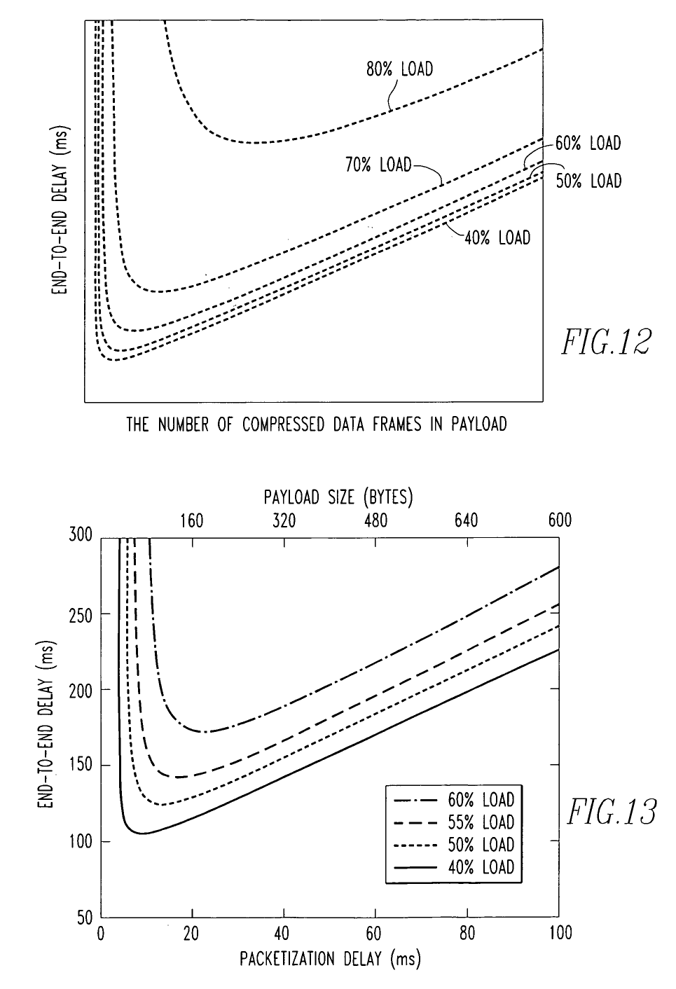

To examine the relationship between packetization delay and network load, delays are plotted at different network loads. FIGS. 11 and 12 are generalized for any speech coding. FIG. 11 plots packetization delay and queuing delay at different network loads. The gap between each load curve shows that the level of queuing delay goes up dramatically at very high load, which is inevitable. When network load rises, optimal packetization cannot reduce delay. However, choosing the right packetization delay is critical to the reliability of the voice call. For instance, a VoIP call across the Internet may have an acceptable delay for several minutes, and then the sound may become noisy and then disappear. This event often happens because packetization delay is usually pre-defined. Suppose the call is in good shape at network loads up to 70 percent in FIG. 11. When the network load increases to 80 percent (FIG. 11), the pre-defined packetization delay causes congestion to collapse and results in huge packet drop or connection failure.

In FIG. 12, end-to-end delay at different network loads is plotted. The end-to-end delay is the sum of each queuing delay curve and the packetization delay curve from FIG. 11. The end-to-end delay is affected heavily by queuing delay on the left side of the optimal point; whereas on the right side, it is affected by packetization delay. There is just a small range of packetization delay for each network load curve that allows low end-to-end delay. By drawing a straight line connecting the optimal point of each curve, it shows that allowable lowest end-to-end delay depends on packetization delay and network load. As the network load increases, more packetization delay (bigger payload size) may be necessary to retain the lowest end-to-end delay. In practice, this relationship cannot be easily utilized. If there is any scheme available that is capable of sensing or predicting the network load experienced by the voice flow, then adaptive packetization could lower delay budget for voice over IP.

The delay performance of a voice call established across the Internet is now examined. According to the present model, the one-way end-to-end delay experienced by a voice packet can be written as
D(t)=Tₚ(N)+[d(t)+T_{q}(ρ, N)] (Eq. 22)
It is assumed that end-to-end delay is the sum of packetization delay and queuing delay in Equation 22 and that other delays are relatively small or can be added later. The first term is the packetization delay derived from Equation 10. The second term is the total queuing delay caused by the Internet, which consists of inherent Internet delay (d(t)) and the queuing delay derived from Equation 9. In practice, the network load (ρ) varies in time and should be written as ρ(t). Since network load is considered to be a factor, different network loads affect end-to-end delay. Inherent Internet delay is run by a network emulator and varies over time. The end-to-end delay changes over time and the result will be handled statistically. For the analysis, the expected value of inherent Internet delay is used and the result will average end-to-end delay.

The following example summarizes the parameters used in the analysis. The average inherent Internet delay (d) is 70 milliseconds. The background traffic is a Poisson process and its average packet size (p) is 250 bytes. The link capacity of the queue (c) is 256 Kbps. The header size of voice packet (h) is 40 bytes. For speech coding, parameters are referred to Table 2. Two variable factors are the number of compressed data frames in payload (N) and network load condition (ρ). Three speech coding standards—G.711, G.726 and G.729—are compared.

The analytical results are shown in FIGS. 13, 14 and 15 for G.711, G.726 and G.729, respectively. For these figures, instead of showing the end-to-end delay as a function of the number of compressed data frames in payload, the voice frame delay of the corresponding speech coding is multiplied to give packetization delay. This will clearly show the trade-off against packetization delay. Also, the corresponding payload size is shown on the top of the plot.

Choosing packetization delay is critical to end-to-end delay and to the reliability of the voice call. In general, packetization delay is pre-defined. The more interesting issue is the practically optimal packetization delay, which is pre-defined, but can work well in most situations. Good packetization delay should allow low end-to-end delay and, at the same time, will not cause congestion collapse when the network load varies. From FIG. 13, G.711 normally requires high network bandwidth. Thus, it can work well under low network load. The practically optimal packetization delay is about 18 to 20 milliseconds (144 to 160 bytes of payload size). This allows acceptable end-to-end delay (around 150 milliseconds) at load up to 55 percent. However, the end-to-end delay is increased a little bit at lower network load.

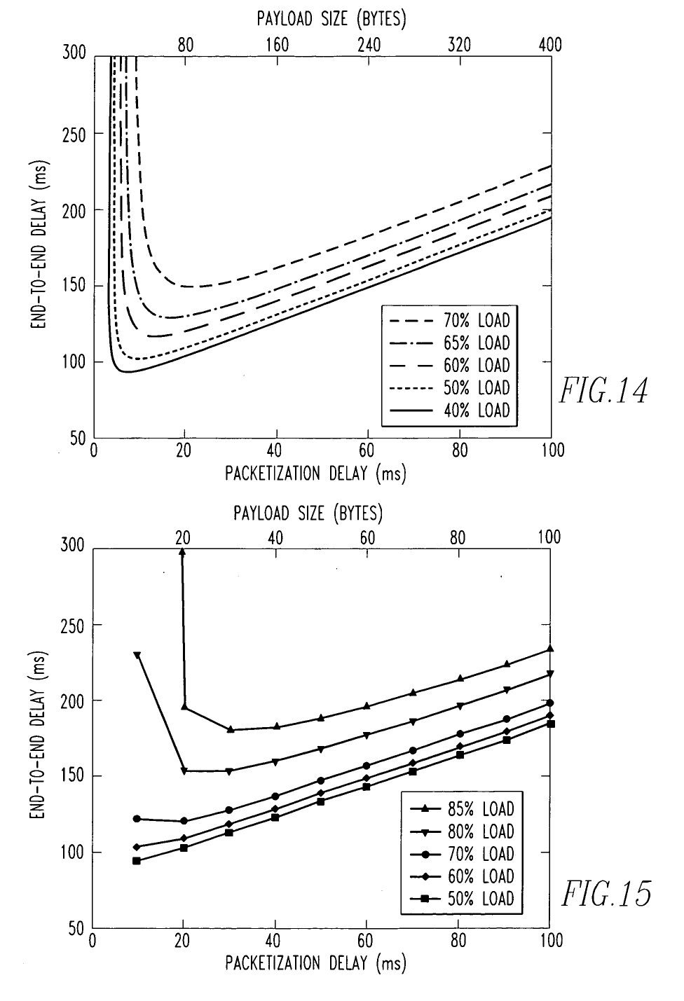

From FIG. 14, G.726 has better delay performance than G.711 at the same load because it requires lower network bandwidth. Particularly at increasing network load, G.726 performs much better than G.711. The practically optimal packetization delay is about 14 to 16 milliseconds (56 to 64 bytes of payload size) and it allows acceptable end-to-end delay at network loads up to 65 percent. G.729, one of the most practical speech codings for voice over IP, requires very low network bandwidth. Choosing packetization delay for G.729 has fewer choices because its algorithm requires 10 milliseconds of voice signal to generate a compressed data frame. From FIG. 15, G.729 generally will not cause congestion collapse, except at very high network loads such as 90 percent. This is because the lowest packetization delay (10 milliseconds) is still beyond the breakout point. The practically optimal packetization delay is at 20 milliseconds (20 bytes of payload size), which allows acceptable end-to-end delay at network loads up to 80 percent. Therefore, a voice call using G.729 will have better reliability and network load can vary down or up while the end-to-end delay is in an acceptable range. In fact, 10-millisecond packetization delay is also excellent. It allows superb end-to-end delay performance with the price of lower reliability.

### EXAMPLE 1

In accordance with the model, as disclosed above, the trade-off between packetization delay and end-to-end delay is studied by an experiment. The advantage of an experiment is that it is conducted in a realistic environment and more details of its results can be investigated. However, an experiment in a totally real environment has several limitations and problems like controlled factors, reproducibility, and measurement. In the experiment, an intermediate solution is applied in which network emulations are interconnected with real equipment. This allows more control over interesting factors. In addition, while the desired measurement is unidirectional packet delay over a wide area network, one major problem for this kind of measurement is its precision. Because transmitting and receiving devices are in remote locations, it is really difficult, or extremely expensive, that measurement equipments can get clock synchronized between two distant probing points. The experiment takes advantage of network emulation so that transmitting and receiving devices can be nearby and a simple measurement can be effective.

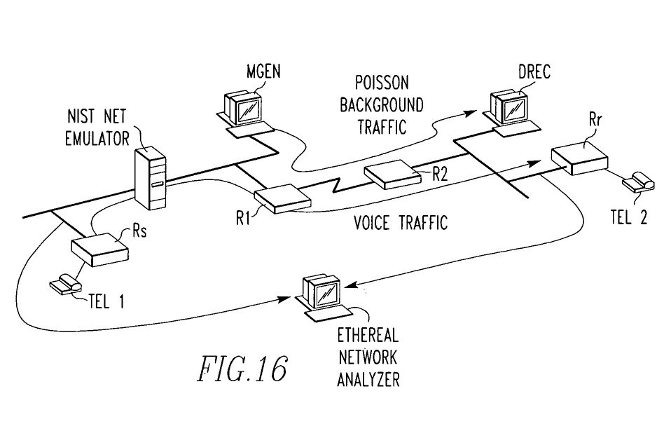

The experiment setup is shown in FIG. 16. NIST Net is a network emulation package running on Linux. It is a general-purpose tool for emulating network conditions like bandwidth limitation, packet delay, and loss. In the experiment, only the emulated delay was enabled and used as an inherent delay of the Internet. The bandwidth limitation and packet loss were not enabled to ensure that any packet drop was only caused by router's queue. The NIST Net machine served as an emulation of the Internet. It had two Ethernet cards, each connected to a sub-network Ethernet LAN. The NIST Net package provides several packet delay distribution options. The Pareto-normal delay distribution was chosen, as it corresponds to reference studies of the Internet's delay. The delay distribution was empirically parameterized to match observed packet delay. However, since no information about the observation of packet delay was provided, an experiment was conducted to verify the delay distribution. The UDP/RTP traffic was transmitted from one subnet, across the emulator, to the subnet on the other end. The packet delay was measured and the result was found to have a mode at the very left side and long tail to the right. The inherent Internet delay setup on NIST Net had a mean at 70 milliseconds and standard deviation of 10 milliseconds. Note that this is a unidirectional delay distribution. The delay distribution ranges from 60 to 120 milliseconds, with a mode around 65 milliseconds.

Router R1 and R2 are Cisco 2500 series, a widely used router model in the Internet. The WAN link capacity between R1 and R2 was limited to 256 Kbps to create a bottleneck in the network. This represents the weakest network link that a voice flow must pass through. The controlled background traffic was also transmitted across the bottleneck to emulate different offered load levels.

MGEN, a program running on a Sun Solaris, was used to generate background traffic. MGEN is a set of programs that provide the ability to perform IP-based network measurements. It can generate a variety of traffic patterns. Destination address and port number, packet size, transmission pattern and rate are configurable. In the experiment, the generated traffic had the Poisson pattern with packet size of 250 bytes, an average packet size in the Internet. The transmission rate (packet per second) can be simply calculated as the percentage of offered load multiplied by the link capacity and divided by the packet size. The receiver of the generated traffic, called DREC, was located on another subnet on the other side of the bottleneck.

Router Rs and Rr are each a Cisco 3640, which supports voice over IP capabilities. Each router was directly connected to a conventional telephone via its FXS interface. The router performed voice sampling, digitizing, coding and prepared IP packets to be transmitted to the network. In the experiment, a voice call was established from telephone Tel1 across the network to Tel2. Instead of conversing over the connection, the voice source was set to ensure that constant bit rate (CBR) traffic was generated with no silence during the call. The call lasted approximately two minutes and only the one-way voice traffic from router Rs to Rr was monitored.

In the actual network connection, shown in FIG. 16, each Ethernet sub-network was an Ethernet switch Cisco 2900 series. To measure packet delay, both Ethernet switches connected to router Rs and Rr had a connection to a hub connected to the Ethereal protocol analyzer. The connection from the router Rs side was configured so that every packet transmitted from router Rs to NIST Net was copied and sent, via the hub, to the protocol analyzer. In the same manner, the connection from the router Rr side copied every packet from router R2 to Rr and sent them, via the hub, to the protocol analyzer. Because only one protocol analyzer, namely one clock, was used to monitor transiting packets, we can accurately measure one-way network delay. The protocol analyzer captured every packet transmitted from Rs to NIST Net and from R2 to Rr. Two duplicate copies of every single packet with different time stamps were recorded and, then, manipulated for interesting results.

The voice coding was the G.729 standard, which is one of the most practical choices for voice over IP today. The same as in the analysis, the two factors are packetization delay and offered load. The packetization delay, configurable at routers Rs and Rr, ranges from 10 to 60 milliseconds at 10-millisecond increments. Since G.729 requires fairly low overhead bandwidth at packetization delay of 50 milliseconds or more (less than 6.4 Kbps), there is no advantage to using higher packetization delay, which causes even higher end-to-end delay. The offered load levels are at 60, 70, 80 and 85 percent of the bottleneck link.

To obtain performance parameters, the interesting voice flow was filtered out of the captured data. The filtered data consisted of two copies of every voice packet (classified by its RTP sequence number), one with departure time stamp at the source and another with arrival time stamp at the destination. Calculating the unidirectional network delay of each voice packet is straight forward, by subtracting its different time stamps. Then, end-to-end delay can be determined by the sum of network delay and the corresponding packetization delay used by voice packet.

The performance results are in terms of time domain and probability functions, and then the overall result is presented and compared to the previous analysis. At an offered load of 80 percent, the different packetization delay affects network delay and end-to-end delay. First, plots of packet delay, at different packetization delay, are shown in time domain in FIGS. 17A-17D. The bottom horizontal axis is the RTP sequence number of each voice packet. Since each experiment captures two minutes of a voice call, another scale in elapsed time is also shown on the top. The vertical axis shows two scales. On the right is network delay in millisecond. Because packetization delay affects every packet as a constant delay, a plot of end-to-end delay can be shown by adding the network delay plot with its corresponding packetization delay. Hence, the axis on the left is the end-to-end delay as it is added or shifted from the network delay axis. These figures give an idea how the voice would be affected by the delay during the call period. The number of voice packets (the dots) in the plots depends on their packetization delay. For instance, for two minutes, 10 milliseconds of packetization delay results in about 12000 packets and 20 milliseconds results in about 6000 packets.

FIG. 17A shows a situation in which the voice flow, using 10 milliseconds of packetization delay, consumes too much network bandwidth and causes network congestion. The Poisson background traffic usually induces high bursts of packet delay. Nonetheless, bursts are exhibited that have very long periods, up to 15 seconds. These long bursts at end-to-end delay more than 200 milliseconds would result in poor voice quality, especially in conversation. There are also some packet losses during high packet delay period, as dots shown on the bottom horizontal axis. The overall packet loss measured is about 0.5 percent and this indicates a beginning of congestion collapse.

FIGS. 17B, 17C and 17D show improving network delay, respectively, as higher packetization delay requires lower network bandwidth. At 20 milliseconds, the network delay is fairly good, showing several bursts of small duration rather than the long period seen in FIG. 17A. At 30 and 40 milliseconds, much lower network delay can be seen in overall duration with fewer burst, all of shorter duration.

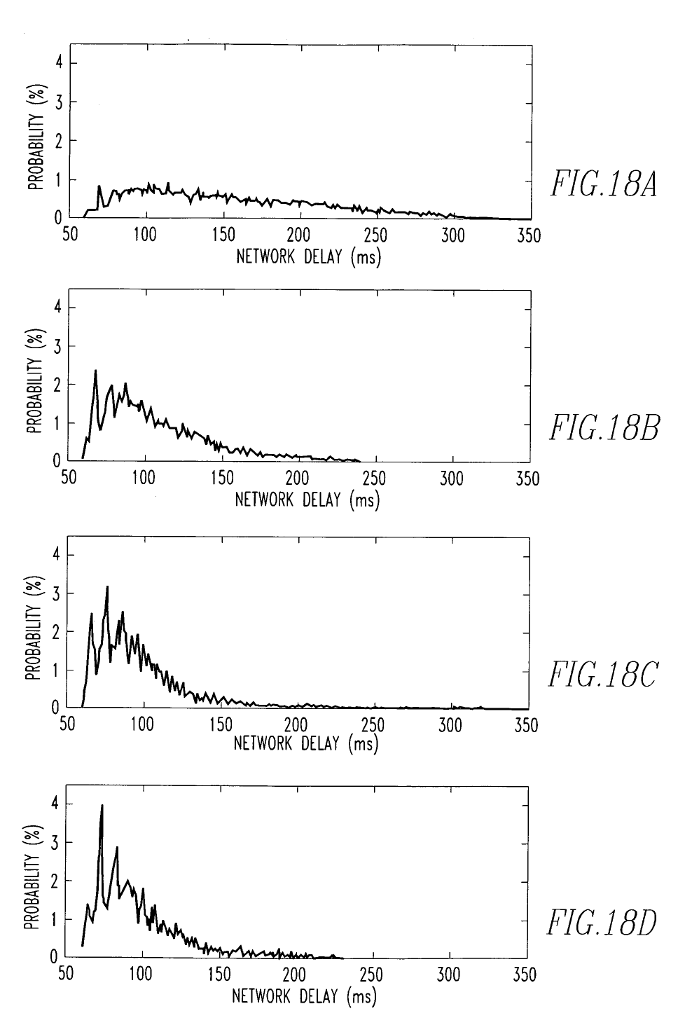

In accordance with the plot in time domain, its probability density function (PDF) is also useful to characterize network delay among the voice flows. Due to the indistinct plot of several curves in the same figure, the corresponding PDF plots of network delay from FIGS. 17A-17D are shown separately in FIGS. 18A-18D, respectively, in the same scale for comparison. The poor network delay distribution is apparently at 10 milliseconds of packetization delay. Its shape has a great contribution from the high network delay, which deviates from the delay distribution of the normal load condition. At 20, 30 and 40 milliseconds, the curves have similar expected shapes with high probability at lower network delay. At higher packetization delay, greater contribution at low network delay results in the higher mode of the shape.

From the plots of packet delay, average packet delay is not good enough to characterize packet delay performance. The delay distribution usually has a right skewed shape. The mode of the delay distribution or the delay percentile is proper to describe the dispersion of packet delay characteristics.

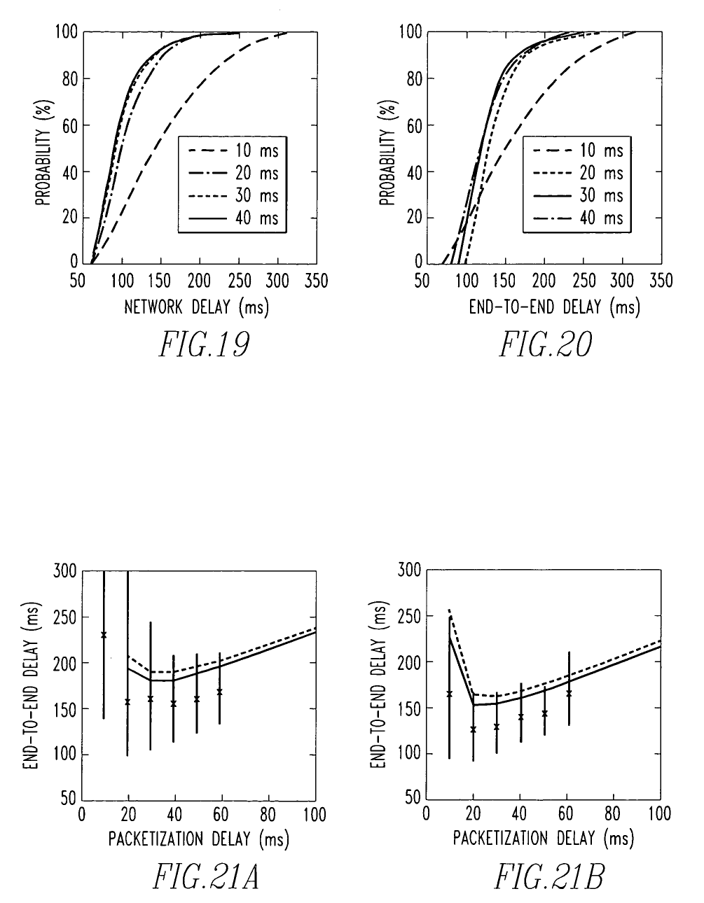

The trade-off between packetization delay and end-to-end delay can be seen in detail by examining their cumulative distribution functions (CDF). FIGS. 19 and 20 are the CDF plot of network delay and end-to-end delay, respectively. From FIGS. 19, 30 and 40 milliseconds of packetization delay almost results in the same distribution. This is because they consume almost the same amount of network bandwidth. Both have better performance than those at 10 and 20 milliseconds, which require more network bandwidth. When packetization delay is taken into account, the curves from FIG. 19 are shifted by their corresponding packetization delay. The end-to-end delay, in FIG. 20 exhibits the inherent trade-off. It is seen that 20 to 30 milliseconds of packetization delay gives the lowest end-to-end delay, while the end-to-end delay for the 40 millisecond curve is affected by its high packetization delay.

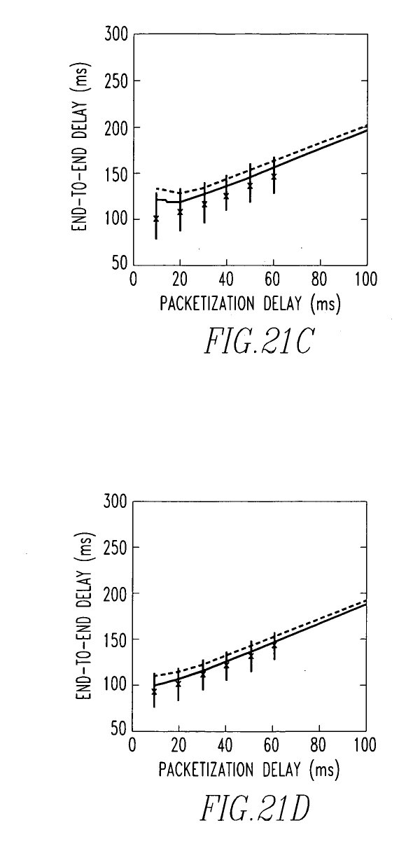

The measured results at different load levels are compared to the investigation of packet delay and the trade-off discussed above. All the measured results follow the analytical result as shown in FIGS. 21A-21D. These plots show end-to-end delay as a function of packetization delay. Two curves of the analytical result are shown. The solid curve is from Equation 12. The dash curve is from Equation 15, which is supposed to be an upper bound. Each measured result is a vertical line, which represents a range of end-to-end delay. The mean end-to-end delay is marked at the middle of the line. The dispersion of end-to-end delay is described by percentile, 90 percent at the top end of the line and 10 percent at the bottom end. In overall, the mean of the measured results is below the solid curves and the 90 percentile of the measured results fits to the dash curves. At 85 percent offered load, the analytical result shows very high end-to-end delay at 10 milliseconds, which is common for simple M/M/1 analysis when no packet drop is considered. Under the same conditions, the measured result is around 300 milliseconds with a compensation of packet loss about 2.5 percent.

Today's Internet telephony, or voice over Internet protocol, still needs more development to overcome its challenges. In terms of voice quality, end-to-end delay is a key parameter. It has a limited budget and the sum of the delay incurred by the VoIP system components may frequently exceed this budget. Any development that can reduce delay in any part of VoIP will help to lower the total end-to-end delay and make VoIP more feasible. For VoIP in private networks, acceptable voice quality can be achieved. Private networks can be fully implemented with available network architectures and techniques. Furthermore, network planning can effectively help to attain the delay goal. In contrast, VoIP in a large public network, such as the Internet, is still questionable. The current Internet model is a best effort service that does not have any service guarantee for voice packet delivery. So voice packet delivery could experience very high delay, beyond the acceptable level. Since it will take years to have an effective quality-of-service mechanism implemented over the Internet, improvements at the end point of VoIP (transmitter and receiver) can assist in reducing end-to-end delay. Packetization is a significant factor, having impact on delay, bandwidth requirement, and queuing delay. Using optimized packetization delay can effectively minimize end-to-end delay and improve voice quality.

Packetization is a process that collects compressed data frames (data of voice signal compressed by speech codings) and places them into a payload of a voice packet. Packetization directly causes a fixed delay, which is the time it needs to wait for a number of compressed data frames. Besides, packetization has inherent impact on bandwidth requirements and queuing delay. Since low packetization delay is desired, a small payload size is employed. The issue is that the voice packet (IP packet) has large header size. Small packets result in low payload-to-overhead ratio; namely, for a certain compressed voice bandwidth, the overhead bandwidth required by packet's header is much higher. Therefore, the network bandwidth requirement for voice packet delivery is usually high, at least 10 Kbps and possibly up to 100 Kbps, depending on the speech coding.

Any speech coding at the same packetization delay requires the same overhead bandwidth requirement—because voice packet's header size is constant. For a given bandwidth channel, high-compression speech coding is preferred so that more bandwidth is available for overhead bandwidth.

Because of large network bandwidth required by voice packet delivery, additional impact comes from the large and highly variable queuing delay. There is an inherent trade-off between packetization delay and end-to-end delay, the sum of packetization delay and queuing delay. The convex curve of end-to-end delay was present. At the optimal packetization, lowest end-to-end delay can be obtained. At very small packetization, queuing delay causes very high end-to-end delay, while, at large packetization beyond the optimal point, packetization delay gradually increases end-to-end delay. In addition, the selected packetization must be larger than the breakout point, at which too small packetization causes network congestion to collapse.

The status of network load is another factor for end-to-end delay. At higher load, the end-to-end delay curve shifts up, while the optimal packetization shifts to the right. This means that larger payload is needed as network load increases. The plot of end-to-end delay at different network loads shows how to choose suitable packetization. Whereas packetization is a pre-defined parameter, selecting the optimal packetization is not simple. The optimal packetization might even be smaller than the breakout point if network load is extremely high. This would result in network overload and poor voice quality. For reliability of the voice call, suitable packetization must be large enough so that its network bandwidth does not cause congestion collapse at any network load conditions.

In the analysis, three speech codings were compared. Based on assumptions, the analytical result showed that G.711 requires the largest packetization delay, 18 to 20 milliseconds (144 to 160 bytes of payload size). Suitable packetization delay for G.726 is 14 to 16 milliseconds (56 to 64 bytes of payload size). For G.729, suitable packetization delay is at 20 milliseconds (20 bytes of payload size).

For the experiment, the same study was conducted on G.729 speech coding. The experimental gave statistical results that show the behavior of voice packet delivery. The comparison between the experimental result and the analytical result was consistent. Due to limitations in the experimental setup, the Poisson background traffic had a constant large packet size. Thus, the service time at the router's queue is not totally exponential and the experimental result could be the lower bound. In conclusion, the actual result should be closed to the analytical result based on Equation 12.

Developing other parts of the end point can contribute to even lower end-to-end delay. The goal is to minimize fixed delays as well as the bandwidth requirement. Because recent speech codings have achieved very low compressed voice bandwidth, from conventional 64 Kbps to 5.3 Kbps, having further compression could be even more difficult. Compression of voice packet header can be studied in order to improve payload-to-overhead ratio. This will result in much lower network bandwidth requirement.

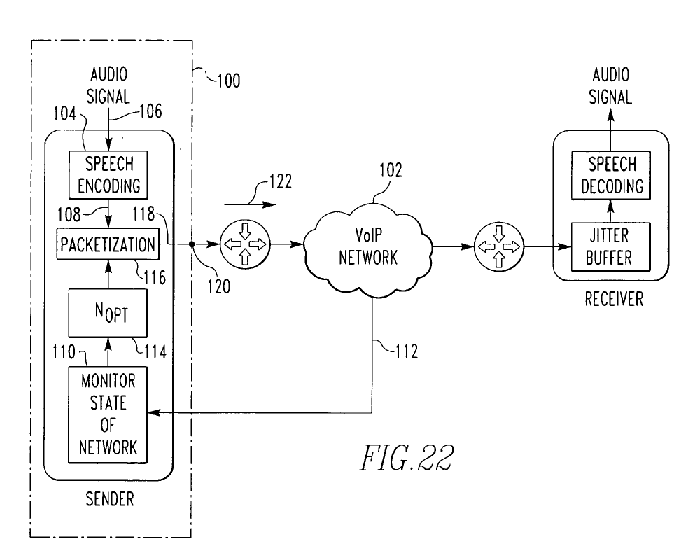

FIG. 22 shows a sending device 100 for a Voice over Internet Protocol (VoIP) network 102. The sending device 100 includes an encoder 104 inputting an audio signal 106 and outputting an encoded audio signal 108. A first circuit 110 monitors a state 112 of the VoIP network 102. A second circuit 114 determines an optimal count (Nₒₚₜ) of compressed data frames from the state 112 of the VoIP network 102. A third circuit 116 employs the optimal count (Nₒₚₜ) to packetize the encoded audio signal 108 in a payload 118. A fourth circuit 120 sends the payload 118 (e.g., in a voice packet 122) to the VoIP network 102.

Since voice encoders generate the output at a constant rate, the delivered quality of voice packet transmission is often degraded due to inadequate available bandwidth from network congestion. The invention applies optimal packetization which allows the sender to transmit voice packet adaptively in different rates, using any constant rate voice encoders.

This invention enables the sender to detect the state of the network and to match its transmission rate to the available network bandwidth. Thereby, the sender is capable of avoiding network congestion and minimizing end-to-end delay. The invention can be implemented at an end system of VoIP networks such as IP phones or PCs, as well as a gateway which connects between PSTN and the Internet. The invention helps to improve end-to-end delay for any VoIP systems.

The invention can improve the perceived quality of voice packet delivery in the current Internet.

### EXAMPLE 2

The disclosed optimization may be implemented initially, at call set-up, and/or in real-time periodically during the call, since changing network load shifts the optimal packetization value.

### EXAMPLE 3

The minimum value of packetization (that yields the least end-to-end delay) changes with network load. Accordingly, it is advantageous to adjust the packetization value.

### EXAMPLE 4

The disclosed implementations of optimizing packetization for a Voice over Internet Protocol network are examples of how the disclosed method, sending device and Voice over Internet Protocol communication system may be implemented. However, the invention is applicable to a wide range of other implementations.

### EXAMPLE 5

For example, the disclosed method, sending device and Voice over Internet Protocol communication system are not restricted to an end-point, but may be added to any network node (e.g., without limitation, a router; a gateway), where the sender's IP stream is re-packetized.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A method of optimizing packetization for a sending device of a Voice over Internet Protocol network, said method comprising:
encoding an audio signal;
monitoring a state of said Voice over Internet Protocol network;
determining an optimal count of compressed data frames from the state of said Voice over Internet Protocol network;
employing said optimal count to packetize said encoded audio signal in a payload; and
sending said payload to said Voice over Internet Protocol network.

2. The method of claim 1 further comprising
minimizing end-to-end delay between a sending device and a receiving device on said Voice over Internet Protocol network.

3. The method of claim 1 further comprising
employing as said encoding an audio signal, sampling, digitizing, companding and coding of said audio signal.

4. The method of claim 1 further comprising
employing a router on said Voice over Internet Protocol network.

5. The method of claim 1 further comprising
determining said optimal count of compressed data frames during set-up of a Voice over Internet Protocol call.

6. The method of claim 1 further comprising
determining said optimal count of compressed data frames in real-time periodically during a Voice over Internet Protocol call.

7. The method of claim 1 further comprising
adjusting said optimal count of compressed data frames.

8. The method of claim 1 further comprising:
sending said payload from a network device of said Voice over Internet Protocol network.

9. A sending device for a Voice over Internet Protocol network, said sending device comprising:
an encoder inputting an audio signal and outputting an encoded audio signal;
a first circuit monitoring a state of said Voice over Internet Protocol network;
a second circuit determining an optimal count of compressed data frames from the state of said Voice over Internet Protocol network;
a third circuit employing said optimal count to packetize said encoded audio signal in a payload; and
a fourth circuit sending said payload to said Voice over Internet Protocol network.

10. The sending device of claim 9 wherein said second and third circuits are structured to minimize end-to-end delay between said sending device and a receiving device on said Voice over Internet Protocol network.

11. The sending device of claim 9 wherein said fourth circuit associates said payload with a plurality of headers in a voice packet and sends said voice packet on said Voice over Internet Protocol network.

12. A Voice over Internet Protocol communication system comprising:
a Voice over Internet Protocol network;
a sending device comprising:
an encoder inputting an audio signal and outputting an encoded audio signal,
a first circuit monitoring a state of said Voice over Internet Protocol network,
a second circuit determining an optimal count of compressed data frames from the state of said Voice over Internet Protocol network,
a third circuit employing said optimal count to packetize said encoded audio signal in a payload, and
a fourth circuit sending said payload to said Voice over Internet Protocol network; and
a receiving device receiving said payload from said Voice over Internet Protocol network.

13. The communication system of claim 12 wherein said second and third circuits cooperate to minimize end-to-end delay between said sending device and said receiving device.

14. The communication system of claim 12 wherein said Voice over Internet Protocol network includes at least one router.

15. The communication system of claim 12 wherein said sending device is an Internet Protocol enabled telephone.

16. The communication system of claim 12 wherein said sending device is a personal computer.

17. The communication system of claim 12 wherein said sending device is a gateway for a Public Switched Telephone Network.

18. The communication system of claim 12 wherein said sending device is a network device of said Voice over Internet Protocol network.

19. The communication system of claim 18 wherein said network device is a router.

20. The communication system of claim 18 wherein said network device is a gateway.
